(19) United States
(12) Patent Application Publication
(10) Pub. No.: US 2017/0102130 A1
(43) Pub. Date: Apr. 13, 2017

(54) NOVEL ROTATING LANTERN

(71) Applicant: Shou Hong HU, Huizhou (CN)

(72) Inventor: Shou Hong HU, Huizhou (CN)

(21) Appl. No.: 15/043,021

(22) Filed: Feb. 12, 2016

(30) Foreign Application Priority Data
Oct. 12, 2015 (CN) 201520787199.7

(51) Int. Cl. F21V 14/02; F21L 4/00; F21L 19/00

(52) U.S. Cl. CPC F21V 14/025; F21L 19/00; F21L 4/00; F21Y 2115/10

(57) ABSTRACT

The present utility model discloses a novel rotating lantern, including: a lampshade, where the top of the lampshade is provided with an upper cover, the top of the upper cover is provided with a lamp top, and the bottom of the lampshade is provided with a bottom cover; and an illumination unit, where the illumination unit is disposed on the top of the interior of the upper cover; the illumination unit includes a rotating motor, a rotating shaft, a light emitting diode (LED) luminaire, and a rotating cover; the rotating motor is embedded in the interior of the upper cover; the top of the rotating shaft is connected to an output end of the rotating motor; the rotating cover shaped like a bowl is connected to the bottom of the rotating shaft; the LED luminaire is annularly embedded in the interior of bowl-shaped space fanned by the rotating cover; and a bowl-shaped inner wall of the rotating cover is a transparent refractor. The novel rotating lantern of the present utility model has features of a strong capability of creating an atmosphere, uniform light, and a beautiful appearance.

### BACKGROUND

Technical Field

The present utility model relates to the technical field of illumination luminaires, decorative luminaires, or festival luminaires, and in particular, to a novel rotating lantern.

Related Art

Lantern, also called storm lantern or camping lantern, is a movable luminaire, and is mainly used in scenarios such as night, insufficient brightness, festivals, and leisure activities. Lantern is popular among consumers due to advantages of light weight and portability. In festival and leisure activities, a main function of a lantern is to enhance festival atmosphere. A lantern with a unique outer appearance arranged in a garden or a walkway may effectively create a joyful atmosphere for the environment. However, currently, common lanterns are of simple structures and monotonous shapes, which greatly limits specific applications of the lanterns.

### SUMMARY

An objective of the present utility model is to provide a novel rotating lantern, which has features of a strong capability of creating an atmosphere, uniform light, and a beautiful appearance.

The present utility model may be implemented by using the following technical solutions.

The present utility model discloses a novel rotating lantern, including: a lampshade, where the top of the lampshade is provided with an upper cover, the top of the upper cover is provided with a lamp top, and the bottom of the lampshade is provided with a bottom cover; and an illumination unit, where the illumination unit is disposed on the top of the interior of the upper cover; the illumination unit includes a rotating motor, a rotating shaft, a light emitting diode (LED) luminaire, and a rotating cover; the rotating motor is embedded in the interior of the upper cover; the top of the rotating shaft is connected to an output end of the rotating motor; the rotating cover shaped like a bowl is connected to the bottom of the rotating shaft; the LED luminaire is annularly embedded in the interior of bowl-shaped space formed by the rotating cover; and a bowl-shaped inner wall of the rotating cover is a transparent refractor. The lantern is provided with the motor. When the LED luminaire illuminates, the motor drives, by using the rotating shaft, the rotating cover to rotate. The rotating cover is a transparent refractor. Therefore, light of the LED luminaire is reflected and refracted by the rotating cover, and then is rotated to generate an effect similar to flashing of a neon light, so as to create a magnificent festival atmosphere, thereby effectively livening up the atmosphere of a festival or leisure activity by using the lantern, and overcoming defects of simple shape and monotonous atmosphere of traditional lanterns. By means of the arranged illumination unit and rotating cover and the LED luminaire annularly arranged in the interior of the bowl-shaped space of the rotating cover, during a usage process, the rotating cover rotates when the LED luminaire illuminates, and LED light is refracted by the rotating cover to form multiple rotating patterns and shapes that are cast on a luminaire decorative piece and the outside of the luminaire, thereby avoiding defects of immovable light and lack of light patterns.

The top of the lamp top is further provided with a hanging ring. The arranged hanging ring makes it convenient to hoist and hang the lantern during a usage process.

The shape of the bottom cover is a regular hexagon; the shape of a cross section of the lampshade is a regular hexagon corresponding to the bottom cover; and the shape of the bottom of the upper cover is a regular hexagon corresponding to the shape of the cross section of the lampshade. The shape of a regular hexagon enables the lantern to have a symmetrical shape and a beautiful appearance.

The shape of the upper cover is a tower top whose bottom is of a regular hexagon shape, and a tower-top-shaped outer wall of the upper cover is provided with several pattern-shaped first decorative holes. The arranged tower-top-shaped upper cover improves a three-dimensional effect of the shape of the whole lantern, and further ensures a beautiful appearance of the lantern. Meanwhile, when the rotating cover rotates, the shape of light changes with the rotating cover, so as to further improve the capability of creating an atmosphere of the lantern.

The lampshade includes a cover body support, and an outer wall of the cover body support is provided with an illumination window. By means of the illumination window, the light can uniformly diffuse outward, so as to ensure an illumination effect of the lantern.

The outer wall of the cover body support is further provided with several pattern-shaped second decorative holes and third decorative holes, and the second decorative holes and the third decorative holes are respectively located at the top and the bottom of the illumination window. The arranged second decorative holes and third decorative holes further ensure a beautiful appearance of the lantern, and improve the independence of the shape.

The bottom cover is further provided with a power supply unit; the power supply unit includes a battery case disposed on the bottom cover and a switch button disposed at the bottom of the bottom cover; a case cover of the battery case is movably buckled at the bottom of the bottom cover; and the switch button is disposed at one side of the case cover. The power supply unit is electrically connected to the LED luminaire of the illumination unit, and the interior of the battery case provides storage space for a battery, so as to ensure portability of the lantern. The switch button arranged at the bottom of the bottom cover makes it convenient to control the whole lantern by using the switch.

An edge of the bottom cover is provided with several installation protruding columns perpendicular to a plane of the top of the bottom cover; several installation grooves are radially provided on the bottom of the lampshade; and the installation protruding columns are embedded into the installation grooves, to flexibly connect the bottom cover and the lampshade.

The interior of the lampshade is further provided with a three-dimensional luminaire decorative piece, and the luminaire decorative piece is disposed at the top of the bottom cover. The arranged luminaire decorative piece adds to the variety of shapes in the interior of the lantern, and further improves an aesthetic effect of the lantern.

The novel rotating lantern of the present utility model has the following beneficial effects:

First, the capability of creating an atmosphere is strong. The lantern is provided with a motor. When the LED luminaire illuminates, the motor drives, by using the rotating shaft, the rotating cover to rotate. The rotating cover is a transparent refractor. Therefore, light of the LED luminaire is reflected and refracted by the rotating cover, and then is rotated to generate an effect similar to flashing of a neon light, so as to create a magnificent festival atmosphere, thereby effectively livening up the atmosphere of a festival or leisure activity by using the lantern, and overcoming defects of simple shape and monotonous atmosphere of traditional lanterns.

Second, the light is uniform. By means of the arranged illumination unit and rotating cover and the LED luminaire annularly arranged in the interior of the bowl-shaped space of the rotating cover, during a usage process, the rotating cover rotates when the LED luminaire illuminates, and LED light is refracted by the rotating cover to form multiple rotating patterns and shapes that are cast on a luminaire decorative piece and the outside of the luminaire, thereby avoiding defects of immovable light and lack of light patterns.

Third, the lantern has a beautiful appearance. The shapes of a regular hexagon and a tower top enable the lantern to have a symmetrical shape and a beautiful appearance.

### BRIEF DESCRIPTION OF THE DRAWINGS

FIG. 1 is an exploded structural diagram of a novel rotating lantern according to the present utility model;

FIG. 2 is a three-dimensional schematic structural diagram of a lampshade of the novel rotating lantern according to the present utility model;

FIG. 3 is an assembly structural diagram of the novel rotating lantern according to the present utility model; and

FIG. 4 is a schematic structural diagram of a bottom cover of the novel rotating lantern according to the present utility model.

Reference signs in the accompany drawings include: 1. hanging ring, 2. lamp top, 3. upper cover, 4. illumination unit, 5. lampshade, 6. bottom cover, 7. rotating motor, 8. rotating shaft, 9. LED luminaire, 10. rotating cover, 11. case cover, 12. first decorative hole, 13. second decorative hole, 14. third decorative hole, 15. illumination window, 16. luminaire decorative piece, 17. battery case, 18. switch button, and 19. installation protruding column.

### DETAILED DESCRIPTION

To provide a better understanding of the technical solutions of the present utility model for a person skilled in the art, the product of the present utility model is further described in detail below with reference to embodiments and accompany drawings.

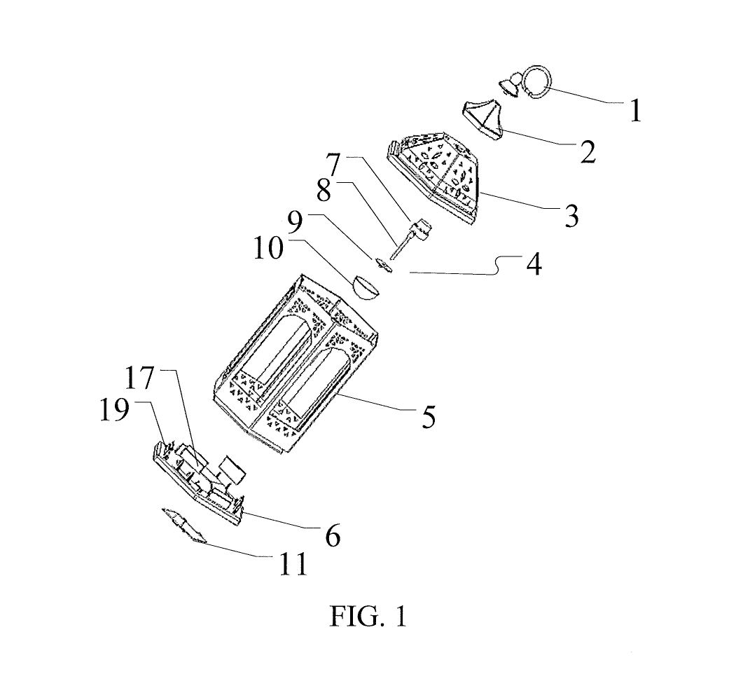

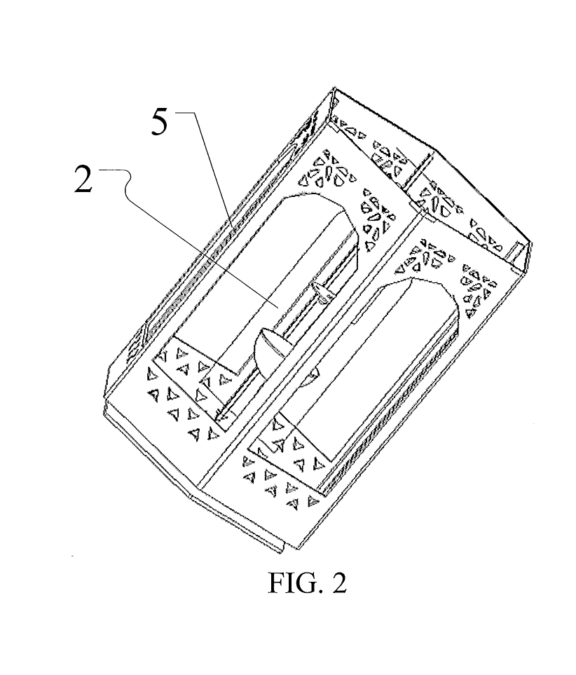

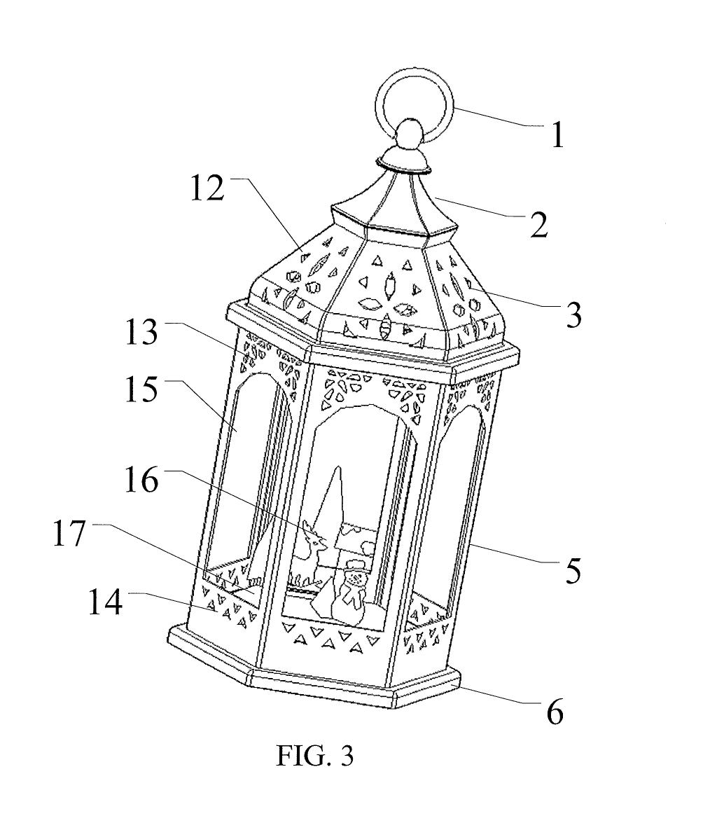

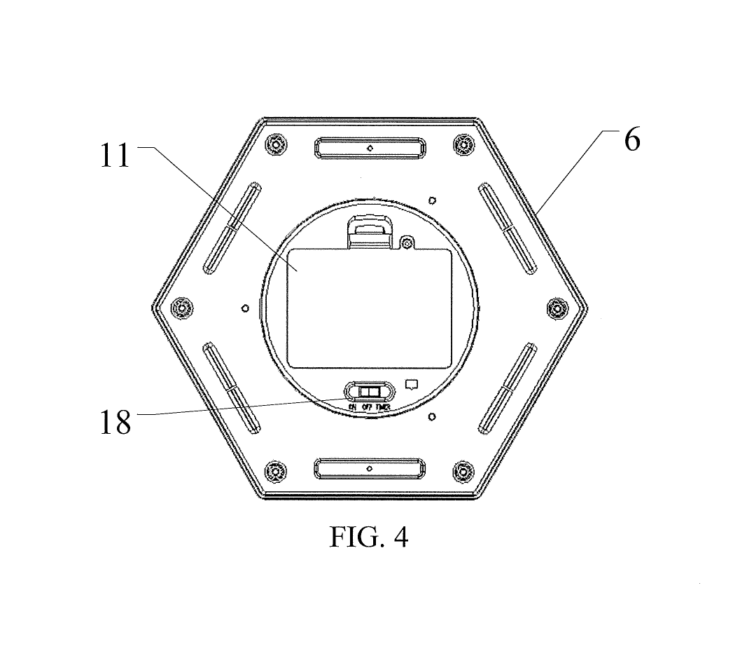

As shown in FIG. 1 to FIG. 4, the present utility model discloses a novel rotating lantern, including: a lampshade 5, where the top of the lampshade 5 is provided with an upper cover 3, the top of the upper cover 3 is provided with a lamp top 2, and the bottom of the lampshade 5 is provided with a bottom cover 6; and an illumination unit 4, where the illumination unit 4 is disposed on the top of the interior of the upper cover 3; the illumination unit 4 includes a rotating motor 7, a rotating shaft 8, an LED luminaire 9, and a rotating cover 10; the rotating motor 7 is embedded in the interior of the upper cover 3; the top of the rotating shaft 8 is connected to an output end of the rotating motor 7; the rotating cover 10 shaped like a bowl is connected to the bottom of the rotating shaft 8; the LED luminaire 9 is annularly embedded in the interior of bowl-shaped space formed by the rotating cover 10; and a bowl-shaped inner wall of the rotating cover 10 is a transparent refractor. The top of the lamp top 2 is further provided with a hanging ring 1. The shape of the bottom cover 6 is a regular hexagon; the shape of a cross section of the lampshade 5 is a regular hexagon corresponding to the bottom cover 6; and the shape of the bottom of the upper cover 3 is a regular hexagon corresponding to the shape of the cross section of the lampshade 5. The shape of the upper cover 3 is a tower top whose bottom is of a regular hexagon shape, and a tower-top-shaped outer wall of the upper cover 3 is provided with several pattern-shaped first decorative holes 12. The lampshade 5 includes a cover body support, and an outer wall of the cover body support is provided with an illumination window 15. The outer wall of the cover body support is further provided with several pattern-shaped second decorative holes 13 and third decorative holes 14, and the second decorative holes 13 and the third decorative holes 14 are respectively located at the top and the bottom of the illumination window 15. The patterns on the rotating cover 10 include rounds, ellipses, half-moons, triangles, diamonds, triangles, rectangles, five-pointed stars, straight lines, snowflake shapes, and the like, and the patterns are colorful. The bottom cover 6 is further provided with a power supply unit; the power supply unit includes a battery case 17 disposed on the bottom cover 6 and a switch button 18 disposed at the bottom of the bottom cover 6; a case cover 11 of the battery case 17 is movably buckled at the bottom of the bottom cover 6; and the switch button 18 is disposed at one side of the case cover 11. An edge of the bottom cover 6 is provided with several installation protruding columns 19 perpendicular to a plane of the top of the bottom cover 6; several installation grooves are radially provided on the bottom of the lampshade 5; and the installation protruding columns 19 are embedded into the installation grooves, to flexibly connect the bottom cover 6 and the lampshade 5. The interior of the lampshade 5 is further provided with a three-dimensional luminaire decorative piece 16, and the luminaire decorative piece 16 is disposed at the top of the bottom cover 6.

The foregoing description is merely a preferred embodiment of the present utility model, and is not intended to limit the present utility model in any form. A person of ordinary skill in the art can smoothly implement the present utility model according to the accompany drawings of this specification and the foregoing description. Moreover, equivalent variations including alternations, modifications, and improvements made to the above-disclosed technical content by a person skilled in the art without departing from the scope of the technical solutions of the present utility model are all equivalent embodiments of the present utility model. Meanwhile, any equivalent variation including alternation, modification, and improvement made to the foregoing embodiment according to the technical essence of the present utility model shall fall within the scope of the technical solutions of the present utility model.

What is claimed is:

1. A novel rotating lantern, comprising: a lampshade (5), wherein the top of the lampshade (5) is provided with an upper cover (3), the top of the upper cover (3) is provided with a lamp top (2), and the bottom of the lampshade (5) is provided with a bottom cover (6); and an illumination unit (4), wherein the illumination unit (4) is disposed on the top of the interior of the upper cover (3); the illumination unit (4) comprises a rotating motor (7), a rotating shaft (8), a light emitting diode (LED) luminaire (9), and a rotating cover (10); the rotating motor (7) is embedded in the interior of the upper cover (3);
the top of the rotating shaft (8) is connected to an output end of the rotating motor (7); the rotating cover (10) shaped like a bowl is connected to the bottom of the rotating shaft (8);
the LED luminaire (9) is annularly embedded in the interior of bowl-shaped space formed by the rotating cover (10); and an bowl-shaped inner wall of the rotating cover (10) is a transparent refractor.

2. The novel rotating lantern according to claim 1, wherein the top of the lamp top (2) is further provided with a hanging ring (1).

3. The novel rotating lantern according to claim 2, wherein the shape of the bottom cover (6) is a regular hexagon; the shape of a cross section of the lampshade (5) is a regular hexagon corresponding to the bottom cover (6); and the shape of the bottom of the upper cover (3) is a regular hexagon corresponding to the shape of the cross section of the lampshade (5).

4. The novel rotating lantern according to claim 3, wherein the shape of the upper cover (3) is a tower top whose bottom is of a regular hexagon shape, and a tower-top-shaped outer wall of the upper cover (3) is provided with several pattern-shaped first decorative holes (12).

5. The novel rotating lantern according to claim 4, wherein the lampshade (5) comprises a cover body support, and an outer wall of the cover body support is provided with an illumination window (15).

6. The novel rotating lantern according to claim 5, wherein the outer wall of the cover body support is further provided with several pattern-shaped second decorative holes (13) and third decorative holes (14); and the second decorative holes (13) and the third decorative holes (14) are respectively located at the top and the bottom of the illumination window (15).

7. The novel rotating lantern according to claim 6, wherein the bottom cover (6) is further provided with a power supply unit; the power supply unit comprises a battery case (17) disposed on the bottom cover (6) and a switch button (18) disposed at the bottom of the bottom cover (6); a case cover (11) of the battery case (17) is movably buckled at the bottom of the bottom cover (6); and the switch button (18) is disposed at one side of the case cover (11).

8. The novel rotating lantern according to claim 7, wherein an edge of the bottom cover (6) is provided with several installation protruding columns (19) perpendicular to a plane of the top of the bottom cover (6); several installation grooves are radially provided on the bottom of the lampshade (5); and the installation protruding columns (19) are embedded into the installation grooves, to flexibly connect the bottom cover (6) and the lampshade (5).

9. The novel rotating lantern according to claim 8, wherein the interior of the lampshade (5) is further provided with a three-dimensional luminaire decorative piece (16), and the luminaire decorative piece (16) is disposed at the top of the bottom cover (6).
